(19) United States
(12) Patent Application Publication
(10) Pub. No.: US 2026/0081242 A1
(43) Pub. Date: Mar. 19, 2026

(54) BATTERY MANAGEMENT SYSTEM AND METHOD FOR VEHICLE USING BATTERY TEMPERATURE PREDICTION MODEL

(71) Applicant: Hyundai Kefico Corporation, Gunpo (KR)

(72) Inventor: Jun Young Ho, Gunpo (KR)

(21) Appl. No.: 19/278,581

(22) Filed: Jul. 23, 2025

(30) Foreign Application Priority Data
Sep. 13, 2024 (KR) 10-2024-0125975

(51) Int. Cl. H01M 10/42; B60L 58/26; G05B 13/02; H01M 10/48

(52) U.S. Cl. CPC H01M 10/425; B60L 58/26; G05B 13/0265; H01M 10/486; B60L 2240/545; B60L 2240/662; B60L 2260/46; H01M 2010/4271; H01M 2220/20

(57) ABSTRACT

A battery management system using a battery temperature prediction model includes: a transmission/reception device for receiving information of a vehicle, a temperature control device for requesting prediction of a battery temperature at a destination arrival time point by using destination information and perform battery conditioning control by using a predicted battery temperature value according to a request result, and a temperature prediction device for outputting the predicted battery temperature value at the destination arrival time point by inputting the information to a battery temperature prediction model, which is provided in advance, in accordance with the request for the prediction of the battery temperature.

### CROSS-REFERENCE TO RELATED APPLICATION

This application claims under 35 U.S.C. § 119(a) the benefit of Korean Patent Application No. 10-2024-0125975, filed in the Korean Intellectual Property Office on Sep. 13, 2024, the entire contents of which are incorporated herein by reference.

### BACKGROUND

### (a) Technical Field

The present disclosure relates to a battery management system and method using a battery temperature prediction model, more particularly, to the system and method configured to predict a temperature of a battery at a time point corresponding to arrival of a vehicle at a destination.

### (b) Description of the Related Art

Vehicles may be classified into electric vehicles (EVs) that acquire power by using only electrical energy, hybrid electric vehicles (HEVs) that acquire power by using both electrical energy and thermal energy produced by combusting fossil fuel, and plug-in hybrid electric vehicles (PHEVs) that use both electrical energy and thermal energy produced by combusting fossil fuel and are capable of charging an embedded battery by receiving electrical energy from the outside.

Battery performance is considered an important factor in a vehicle that uses electrical energy, where chemical properties of the battery are greatly affected by temperature, and charging time may vary depending on a battery temperature.

Therefore, a thermal management technology for maintaining the battery at an optimal temperature (e.g., 20 to 30° C.) is required, which makes it possible to efficiently charge the battery and predict the charging time.

One of the battery thermal management technologies is battery conditioning.

Battery conditioning control refers to a technology for improving battery charging efficiency, i.e., increasing the charge capacity and decreasing the charging time, by controlling battery cooling and heating devices to maintain the battery temperature of about 30° C. or less until the vehicle arrives at a charging station.

The battery conditioning control is performed by predicting a change in battery temperature and adjusting the cooling and heating devices. However, because the battery temperature may vary unexpectedly depending on a traveling environment, there is a need for a method of more precisely predicting the change in battery temperature.

### SUMMARY

The present disclosure provides a battery management system and method for a vehicle using a battery temperature prediction model, the battery management system and method being capable of improving battery charging efficiency by maintaining an optimal temperature state of a battery of the vehicle, for example, by predicting a battery temperature at a charging station arrival time point by using the battery temperature prediction model and performing battery conditioning control on the basis of the battery temperature.

According to the present disclosure, a battery management system for a vehicle using a battery temperature prediction model includes: a transmission/reception device configured to receive information of the vehicle; a temperature control device configured to request prediction of a battery temperature at a destination arrival time point by using destination information and perform battery conditioning control by using a predicted battery temperature value according to a request result; and a temperature prediction device configured to output the predicted battery temperature value at the destination arrival time point by inputting the information to a battery temperature prediction model, which is provided in advance, in accordance with the request for the prediction of the battery temperature.

As provided herein, the vehicle may be an electric vehicle.

As provided herein, the information may include trip-related information, also referred to herein as “traveling information” of a vehicle (e.g., an electric vehicle).

According to another exemplary embodiment of the present disclosure, a battery management system is equipped with a battery temperature prediction model, the battery management system including: a transmission/reception device configured to receive traveling information of an electric vehicle; a temperature control device configured to request prediction of a battery temperature at a destination arrival time point by using destination information of the traveling information and perform battery conditioning control by using a predicted battery temperature value according to a request result; and a temperature prediction device configured to output the predicted battery temperature value at the destination arrival time point by inputting the traveling information to a battery temperature prediction model, which is provided in advance, in accordance with the request for the prediction of the battery temperature.

The traveling information may include destination information, a remaining traveling time, an outside air temperature, a current battery temperature, a rotational speed of an electronic compressor (E-compressor) configured to operate a cooling or heating device, and a coolant temperature.

The battery management system may further include: a model learning device configured to reproduce data related to the battery temperature by dividing a single data set, which is provided on the basis of data related to the battery temperature of the traveling information of the electric vehicle, into a plurality of data sets, setting a last value of the plurality of divided data sets as a destination arrival time point, and calculating a remaining traveling time to a destination when the battery temperature prediction model is learned.

The model learning device may produce learning data by designating a last value of the current battery temperature in the data related to the reproduced battery temperature to a battery temperature at the destination arrival time point and setting a target battery temperature by subtracting the battery temperature at the destination arrival time point from the current battery temperature.

The model learning device may learn the battery temperature prediction model by using a remaining traveling time, an outside air temperature, and a current battery temperature as input values.

The temperature prediction device may calculate the predicted battery temperature value at the destination arrival time point by subtracting a target battery temperature, which is set by the battery temperature prediction model, from the current battery temperature in accordance with the request for the battery temperature prediction.

The battery temperature prediction model may be divided into at least three regions by model partitioning to constitute a pipeline.

The temperature control device may determine whether a destination of the electric vehicle is a charging station on the basis of the traveling information, and the temperature control device may perform the battery conditioning control depending on whether the predicted battery temperature value enters a preset optimal temperature range when the destination is the charging station.

A vehicle (or an electric vehicle) may incorporate the battery management system.

According to the present disclosure, a battery management method of a vehicle using a battery temperature prediction model includes steps of: receiving, by a transmission/reception device, information of the vehicle; requesting, by a temperature control device, prediction of a battery temperature at a destination arrival time point by using destination information of the information; outputting, by a temperature prediction device, the predicted battery temperature value at the destination arrival time point by inputting the information to a battery temperature prediction model, which is provided in advance, in accordance with the request for the prediction of the battery temperature; and performing, by the temperature control device, battery conditioning control by using a predicted battery temperature value according to a request result.

A further exemplary embodiment of the present disclosure provides a battery management method using a battery temperature prediction model, the battery management method including: a traveling information reception step of receiving, by a transmission/reception part, traveling information of an electric vehicle; a temperature prediction request step of requesting, by a temperature control part, prediction of a battery temperature at a destination arrival time point by using destination information of the traveling information; a temperature prediction step of outputting, by a temperature prediction part, the predicted battery temperature value at the destination arrival time point by inputting the traveling information to a battery temperature prediction model, which is provided in advance, in accordance with the request for the prediction of the battery temperature; and a battery conditioning control step of performing, by the temperature control part, battery conditioning control by using a predicted battery temperature value according to a request result.

The traveling information may include the destination information, a remaining traveling time, an outside air temperature, a current battery temperature, a rotational speed of an electronic compressor (E-compressor) configured to operate a cooling or heating device, and a coolant temperature.

The battery management method may further include: a data acquisition step of acquiring, by a model learning part, data related to the battery temperature of the traveling information of the electric vehicle before the temperature prediction request step; a data division step of dividing, by the model learning part, a single data set, which is provided on the basis of data related to the battery temperature of the traveling information of the electric vehicle, into a plurality of data sets; and a data reproduction step of reproducing, by the model learning part, data related to the battery temperature by setting a last value of the plurality of divided data sets as a destination arrival time point and calculating a remaining traveling time to a destination.

The battery management method may further include: a learning data production step of producing, by the model learning device after the data reproduction step, learning data by designating a last value of a current battery temperature in the data related to the reproduced battery temperature to the battery temperature at the destination arrival time point and setting a target battery temperature by subtracting the battery temperature at the destination arrival time point from the current battery temperature.

The battery management method may further include: a learning step of learning, by the model learning device after the learning data production step, the battery temperature prediction model by using a remaining traveling time, an outside air temperature, and a current battery temperature as input values.

The temperature prediction step may include a step of calculating, by the temperature prediction part, the predicted battery temperature value at the destination arrival time point by subtracting a target battery temperature, which is set by the battery temperature prediction model, from a current battery temperature in accordance with the request for the prediction of the battery temperature.

The battery temperature prediction model may be divided into at least three regions by model partitioning to constitute a pipeline.

The battery management method may further include: a destination determination step of determining, by the temperature control device after the traveling information reception step, whether a destination of the electric vehicle is a charging station on the basis of the traveling information; and a temperature determination step of determining, by the temperature control device after the temperature prediction step, whether the predicted battery temperature value enters a preset optimal temperature range when the destination is the charging station.

According to the present disclosure, it is possible to improve the battery charging efficiency by maintaining the optimal temperature state of the battery by predicting the battery temperature at the charging station arrival time point by using the battery temperature prediction model and performing the battery conditioning control on the basis of the battery temperature.

In addition, it is possible to solve the problem of insufficient learning data by applying the over-scaling technique to the battery temperature prediction model.

In addition, it is possible to more accurately perform the battery temperature prediction in consideration of various traveling conditions.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a view for briefly explaining an example of a battery conditioning control operation while an electric vehicle travels toward a destination determined as a charging station.

FIGS. 2A-2C are views for explaining an example of a battery conditioning control process for maintaining an optimal temperature state of a battery.

FIG. 3 is a block diagram of a battery management system equipped with a battery temperature prediction model according to the embodiment of the present disclosure.

FIG. 4 is a graph exemplarily illustrating a battery temperature until arrival at the charging station.

FIG. 5 is a view illustrating a result of over-scaling learning data of the battery temperature prediction model in the present disclosure.

FIGS. 6A-6B are views illustrating an example of setting a target value of a temperature of the battery for learning the battery temperature prediction model in the present disclosure.

FIG. 7 is a view illustrating a structure of the battery temperature prediction model in the present disclosure.

FIGS. 8A-8B are views for explaining a process of dividing a structure of the battery temperature prediction model in the present disclosure.

FIG. 9 is a flowchart of a battery management method using the temperature prediction model according to the embodiment of the present disclosure.

FIG. 10 is a flowchart for explaining a learning process of the battery temperature prediction model in the present disclosure.

FIG. 11 is a view for explaining various types of vehicle information and an actuator device used for battery conditioning control.

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes will be determined in device by the particular intended application and use environment.

In the figures, reference numbers refer to the same or equivalent parts of the present disclosure throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, exemplary embodiments of the present disclosure will be described in detail with reference to the accompanying drawings. First, in assigning reference numerals to constituent elements of the respective drawings, it should be noted that the same constituent elements will be designated by the same reference numerals, if possible, even though the constituent elements are illustrated in different drawings. Further, the exemplary embodiments of the present disclosure will be described below, but the technical spirit of the present disclosure is not limited thereto and may, of course, be modified and variously carried out by those skilled in the art.

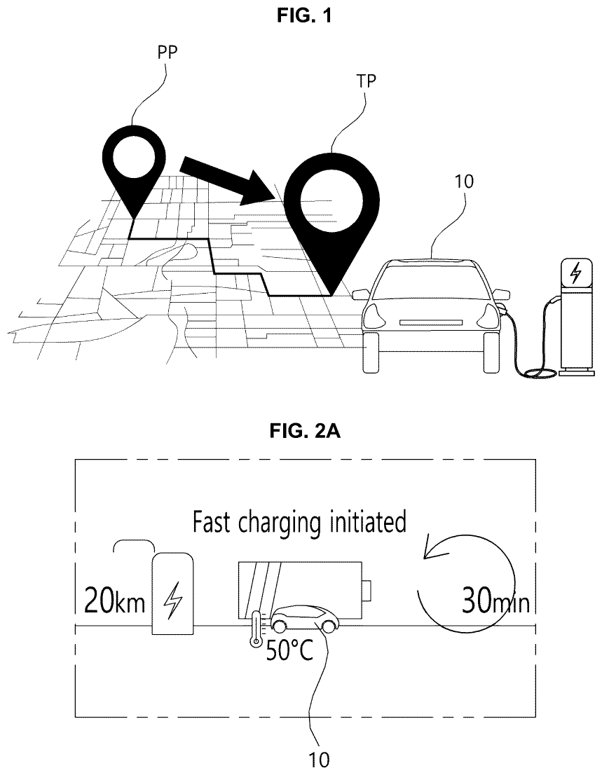

FIG. 1 is a view for briefly explaining an example of a battery conditioning control operation while a vehicle (e.g., an electric vehicle) travels toward a destination determined as a charging station.

With reference to FIG. 1, in case that a battery charge level of an electric vehicle 10 decreases and a charging station is set as a destination TP, a battery conditioning control function of the electric vehicle 10 may be performed in consideration of a remaining traveling time from a current position PP to the destination TP.

In the embodiment, in case that the remaining traveling time to the destination TP is 60 minutes, a battery may be cooled for approximately 40 minutes in accordance with battery conditioning control, and then the battery conditioning control function may be turned off.

In another embodiment, in case that the remaining traveling time to the destination TP is 60 minutes, the battery may be cooled for approximately 60 minutes in accordance with the battery conditioning control, and then the battery conditioning control function may be turned off.

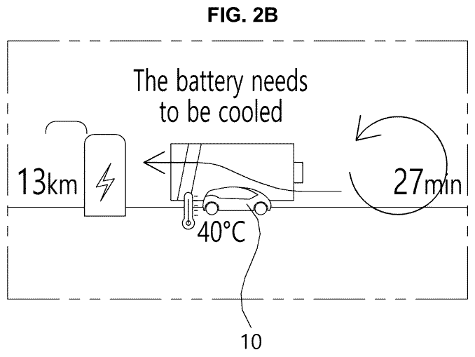

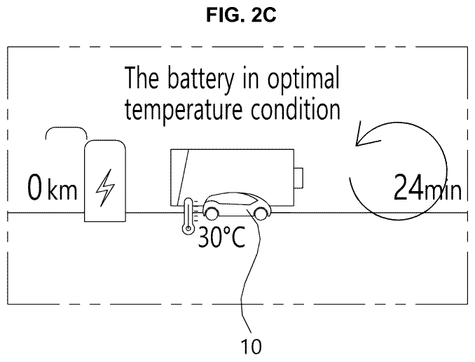

FIGS. 2A-2C are views for explaining an example of a battery conditioning control process for maintaining an optimal temperature state of a battery.

FIG. 2A illustrates an expected battery charging time at a destination selection time point. In FIG. 2A, the electric vehicle 10 may receive information on a destination (e.g., a charging station) through a navigation device.

When the charging station is inputted as the destination, a battery management system of the electric vehicle 10 may identify a current battery temperature, an arrival distance to the charging station, and an expected battery charging time.

For example, the current battery temperature may be 50° C., the arrival distance to the charging station may be 20 km, and an expected battery charging completion time may be 30 minutes (min).

FIG. 2B illustrates the expected battery charging time while the electric vehicle travels toward the destination.

In FIG. 2B, the battery management system of the electric vehicle 10 may perform the battery conditioning control function while the electric vehicle 10 travels toward the destination.

The battery conditioning control function may make map data of cooling or heating time required to reach the optimal temperature state of the battery in accordance with a current battery temperature and an outside air temperature.

In addition, the battery conditioning control function may compare the cooling or heating time, which is required to reach the optimal temperature state of the battery, with a remaining traveling time to the charging station.

In addition, the battery conditioning control function may perform battery cooling control in case that the remaining traveling time coincides with the cooling or heating time required to reach the optimal temperature state.

When the arrival distance to the charging station is 13 km as a battery cooling device is turned on, the battery temperature may be 40° C., and the expected battery charging time may be 27 minutes (min).

FIG. 2C illustrates an expected battery charging time at a destination arrival time point.

In FIG. 2C, when the electric vehicle 10 arrives at the charging station, the battery temperature may be maintained as the optimal temperature state (30° C.), and the expected battery charging time may be 24 minutes (min).

However, in the case of a battery conditioning method using a rule-based technique illustrated in FIG. 2, there may occur a situation in which a change in battery temperature cannot be accurately predicted because of influences of various traveling environments.

Therefore, there is a need for a method capable of optimizing and controlling the battery temperature and preventing unnecessary battery cooling or heating by more accurately predicting the battery temperature at the charging station arrival time point in consideration of a current state of the vehicle, a traveling condition, and a surrounding environment.

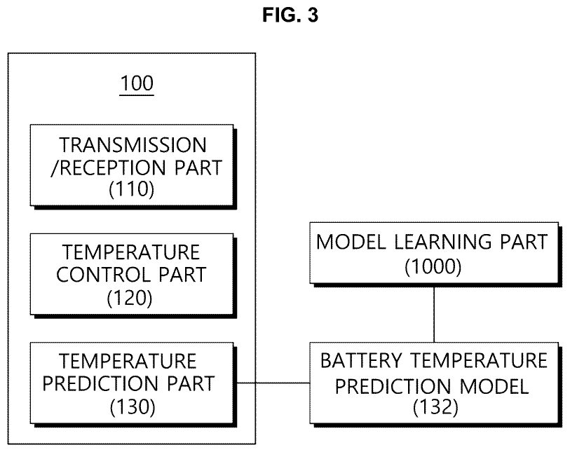

FIG. 3 is a block diagram of the battery management system equipped with the battery temperature prediction model according to the embodiment of the present disclosure.

With reference to FIG. 3, a battery management system 100 equipped with a battery temperature prediction model according to an embodiment of the present disclosure includes a transmission/reception device 110, a temperature control device 120, and a temperature prediction device 130.

Each of the above devices 110, 120, and 130 may constitute modules and/or units of a controller. For example, the above devices of the controller may constitute hardware components that form part of a controller (e.g., modules or units of a high-level controller), or may constitute individual controllers each having a processor and memory. The controller may include one or more processors and memory.

The transmission/reception device 110 may communicate with various types of controllers of the electric vehicle 10. In addition, the transmission/reception device 110 may receive destination information, which is inputted by a user, from the navigation device. The transmission/reception device 110 may receive, from various types of controllers of the electric vehicle, traveling information including a remaining traveling time, an outside air temperature, a current battery temperature, a rotational speed of an electronic compressor (E-compressor) configured to operate the cooling or heating device, a coolant temperature, and the like. In addition, the destination information may be included in the traveling information. As provided herein, “traveling information” includes any information relevant to an electric vehicle, and may be referring to herein as simply “information” of the electric vehicle.

The temperature control device 120 may determine whether the destination of the electric vehicle 10 is the charging station on the basis of the destination information. In case that the destination of the electric vehicle 10 is the charging station, the temperature control device 120 may determine that the battery conditioning control is required.

When the temperature control device 120 performs the battery conditioning control, the temperature control device 120 may request the temperature prediction device 130 to predict the battery temperature at the charging station arrival time point.

The temperature control device 120 may perform the battery conditioning control in consideration of a predicted temperature value predicted by the temperature prediction device 130. The battery conditioning control may include cooling control using the cooling device, and heating control using the heating devices.

In case that the temperature prediction device 130 receives the request for the battery temperature prediction from the temperature control device 120, the temperature prediction device 130 may predict the battery temperature at the charging station arrival time point by using a battery temperature prediction model 132 provided in advance. In the embodiment, the temperature prediction model 132 is a model learned to predict the temperature of the battery upon arrival at the charging station by using a traveling state of the vehicle, a traveling condition, and traveling environment information as model input information. The temperature prediction model 132 may be provided and learned in advance by a separate model learning device 1000.

The temperature prediction device 130 may receive, from the temperature control device 120, a remaining traveling time, an outside air temperature, a current battery temperature, a rotational speed of the electronic compressor (E-compressor) configured to operate the cooling or heating device, a coolant temperature as the model input information.

The temperature prediction device 130 may output a predicted battery temperature value at the charging station arrival time point by inputting the model input information to the battery temperature prediction model 132. The temperature prediction device 130 may transmit the predicted battery temperature value to the temperature control device 120.

The temperature control device 120 may control the temperature of the battery on the basis of the predicted battery temperature value. In the embodiment, the temperature control device 120 performs the battery conditioning control so that the predicted temperature value of the battery at the charging station arrival time point is included in an optimal range for charging the battery. For example, the temperature control device 120 maintains the rotational speed of the electronic compressor in an intact manner in case that the battery temperature is maintained within a predetermined range upon arrival at the charging station in consideration of the current rotational speed of the electronic compressor configured to operate the cooling or heating device, the traveling state of the vehicle, and the surrounding environment information.

However, in case that the battery temperature upon arrival at the charging station, which is predicted in accordance with a current cooled or heated state of the battery, deviates from the predetermined range, the temperature control device 120 may perform control to maintain the optimal temperature by adjusting a cooling or heating condition of the battery.

In the embodiment, the temperature prediction of the temperature prediction device 130 and the battery temperature control of the temperature control device 120 may be performed repeatedly until the electric vehicle 10 arrives at the charging station.

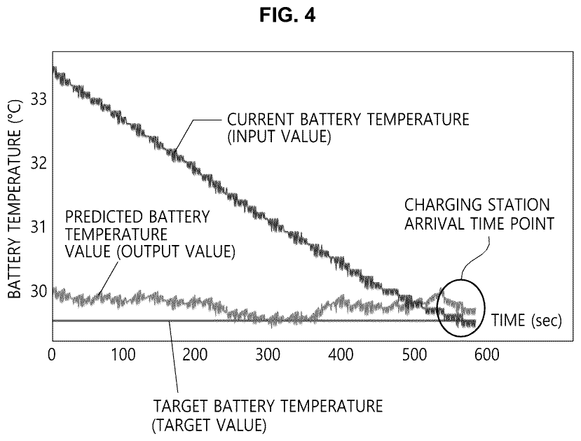

FIG. 4 is a graph exemplarily illustrating a battery temperature until arrival at the charging station.

FIG. 4 exemplarily illustrates a target battery temperature, a current battery temperature, and a predicted battery temperature value predicted by the temperature prediction device 130. In FIG. 4, the predicted battery temperature value is a value made by predicting a battery temperature upon arrival at the charging station on the basis of the current state information of the electric vehicle 10. The temperature control device 120 may control the temperature of the battery on the basis of the predicted battery temperature value calculated by the temperature prediction device 130, such that the battery temperature upon arrival at the charging station may be adjusted to reach the target battery temperature.

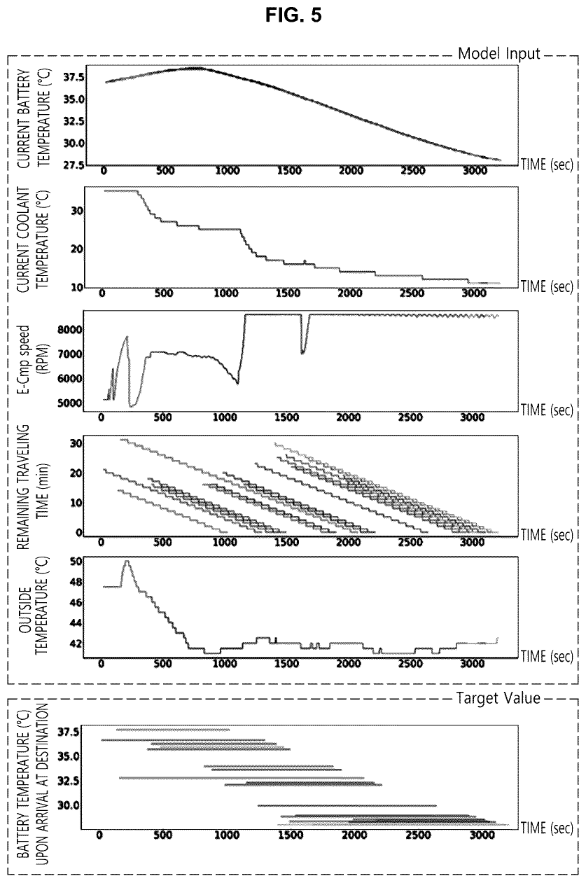

FIG. 5 is a view illustrating a result of over-scaling learning data of the battery temperature prediction model in the present disclosure.

With reference to FIG. 5, the model learning device 1000 may apply an over-scaling technique to solve a problem of insufficient learning data when the model learning device 1000 learns the battery temperature prediction model 132 provided in the temperature prediction device 130.

The model learning device 1000 may arbitrarily divide a single data set, which is provided on the basis of the traveling information, into a plurality of data sets. In this case, redundancy may be allowed.

The model learning device 1000 may set a last value of the plurality of divided data sets as the destination arrival time point and calculate the remaining traveling time to the destination.

The model learning device 1000 may designate a last value of the current battery temperature in the plurality of divided data sets to a battery temperature (a model learning value or a target value) at the destination arrival time point.

FIG. 5 illustrates one data set related to current battery temperatures, current coolant temperatures, rotational speeds of the electronic compressor, the remaining traveling times to the destination, and outside air temperatures in model inputs. One data set is divided into a plurality of data sets, and the divided data sets are distinguished by colors for each of the model inputs. Redundancy in the data sets may be allowed when the data set is divided. In addition, the battery temperature, which is the target value in each of the divided data sets, is set as the last value of the current battery temperature.

With the above-mentioned method, the model learning device 1000 may ensure the plurality of data sets by means of the single data set. Therefore, it is possible to solve the problem of insufficient learning data.

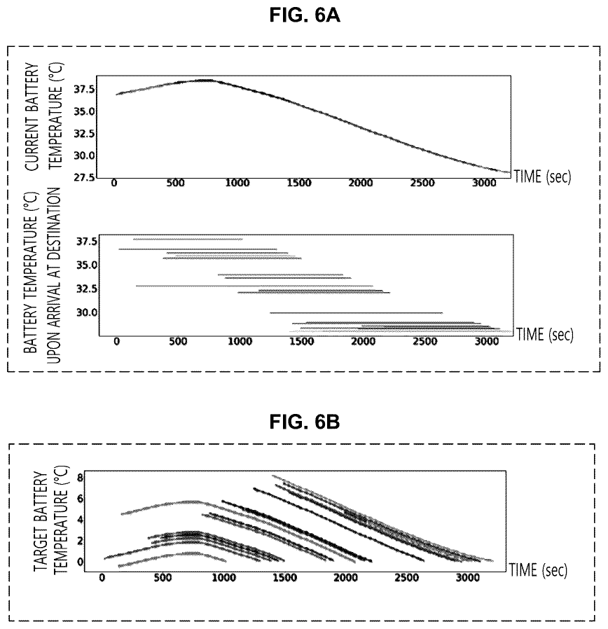

FIGS. 6A-6B are views illustrating an example of setting the target value of the temperature of the battery for learning the battery temperature prediction model in the present disclosure.

FIG. 6A illustrates the current battery temperature and the battery temperature at the destination arrival time point. FIG. 6B illustrates the target battery temperature that is the target value of the battery temperature.

In the example in FIG. 6, because the target battery temperature, which is the target value of the battery temperature in the data for the model learning, is a value fixed over time, there may occur a problem in that a loss value may diverge instead of converging when the battery temperature prediction model is learned.

The model learning device 1000 may set the target battery temperature by subtracting the battery temperature (model learning value) at the destination arrival time point from the current battery temperature. The target battery temperature may be set as a value that changes over time. Therefore, it is possible to prevent the problem in which a loss value diverges.

The model learning device 1000 may calculate the predicted battery temperature value at the destination arrival time point by subtracting the target battery temperature from the current battery temperature.

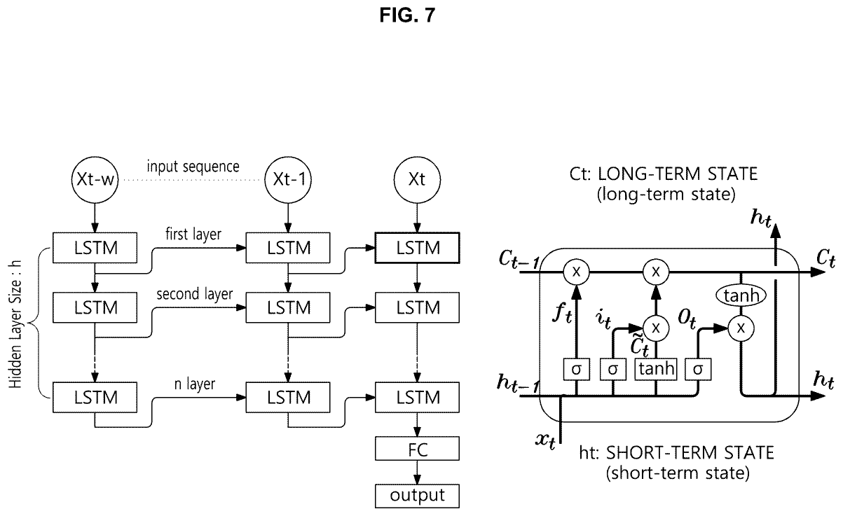

FIG. 7 is a view illustrating a structure of the battery temperature prediction model in the present disclosure.

With reference to FIG. 7, the battery temperature prediction model 132 may have a structure of 3-layer LSTM. The properties of the battery temperature prediction model 132 may be shown in Table 1 below.

TABLE 1

| Time step | 1 sec |
|---|---|
| History step(sliding window) | 60 sec |
| Number of layers | 3 |
| Hidden dimension | 256 |

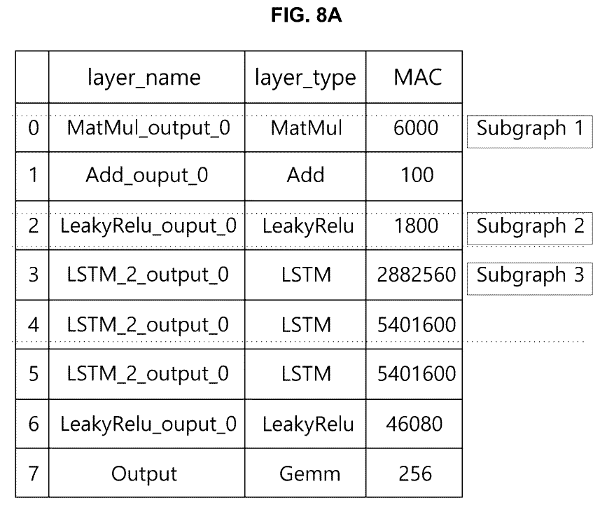

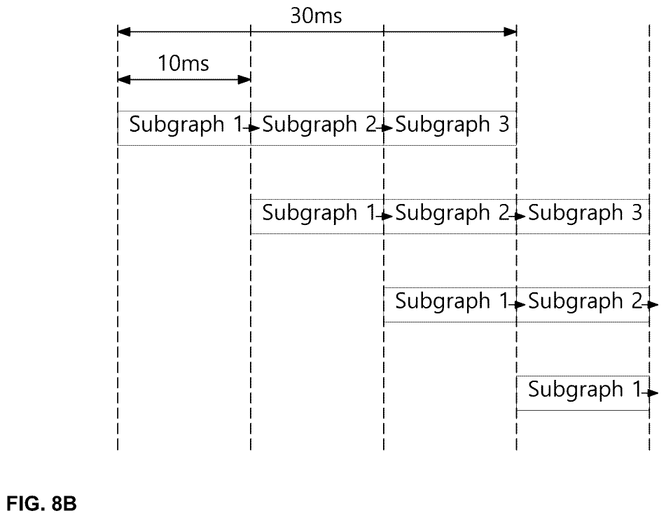

FIGS. 8A-8B are views for explaining a process of dividing the structure of the battery temperature prediction model in the present disclosure.

FIG. 8A illustrates a 3-layers LSTM MAC prediction result. FIG. 8B illustrates a pipeline and a multi-thread configuration.

With reference to FIG. 8, the model learning device 1000 may perform MAC prediction (estimation) in accordance with a graph analysis of the 3-layer LSTM.

The model learning device 1000 may divide the battery temperature prediction model 132 into three regions (Subgraph 1, Subgraph 2, Subgraph 3) on the basis of the MAC prediction result.

The model learning device 1000 may constitute the pipeline and the multi-thread in accordance with the division of the battery temperature prediction model 132. With the core allocation and the pipeline configuration, the processing time of the battery temperature prediction model 132 may be reduced.

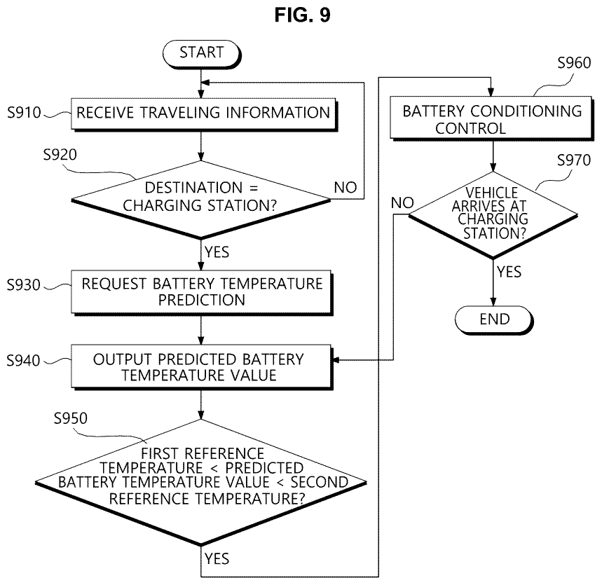

FIG. 9 is a flowchart of a battery management method using the temperature prediction model according to the exemplary embodiment of the present disclosure.

With reference to FIG. 9, the battery management method using a temperature prediction model according to the exemplary embodiment of the present disclosure is characterized by improving the battery charging efficiency by maintaining the optimal temperature state of the battery by predicting the battery temperature at the charging station arrival time point by using the battery temperature prediction model 132 and performing the battery conditioning control on the basis of the battery temperature.

In a traveling information reception step S910, the transmission/reception device 110 may receive the traveling information from various types of controllers of the electric vehicle 10. The traveling information may include the destination information, the remaining traveling time, the outside air temperature, the current battery temperature, the rotational speed of the electronic compressor (E-compressor) configured to operate the cooling or heating device, and the coolant temperature.

In a destination determination step S920, the temperature control device 120 may determine whether the destination of the electric vehicle 10 is the charging station on the basis of the traveling information.

In a temperature prediction request step S930, the temperature control device 120 may request the prediction of the battery temperature at the destination arrival time point when it is determined that the destination of the electric vehicle 10 is the charging station.

In a temperature prediction step S940, the temperature prediction device 130 may output the predicted battery temperature value at the destination arrival time point by inputting the traveling information to the battery temperature prediction model 132 provided in advance in accordance with the request for the prediction of the battery temperature. The temperature prediction device 130 may output the predicted temperature value at the destination arrival time point by subtracting the output battery temperature of the battery temperature prediction model from the current battery temperature.

In a temperature determination step S950, the temperature control device 120 may determine whether the predicted battery temperature value is included in a preset optimal temperature range. The optimal temperature range may include a temperature between a first reference temperature and a second reference temperature. The first reference temperature may be 29 degrees. The second reference temperature may be 30 degrees.

In a battery conditioning control step S960, the temperature control device 120 may perform the battery conditioning control when the predicted battery temperature value enters the preset optimal temperature range. The temperature control device 120 may adjust the battery temperature by controlling a cooling or heating actuator by means of the battery conditioning control.

In an arrival determination step S970, the temperature control device 120 may determine whether the electric vehicle 10 arrives at the destination. The temperature control device 120 may end the battery conditioning control when it is determined that the electric vehicle 10 arrives at the destination. Therefore, the optimal temperature state of the battery may be maintained when the electric vehicle 10 arrives at the destination.

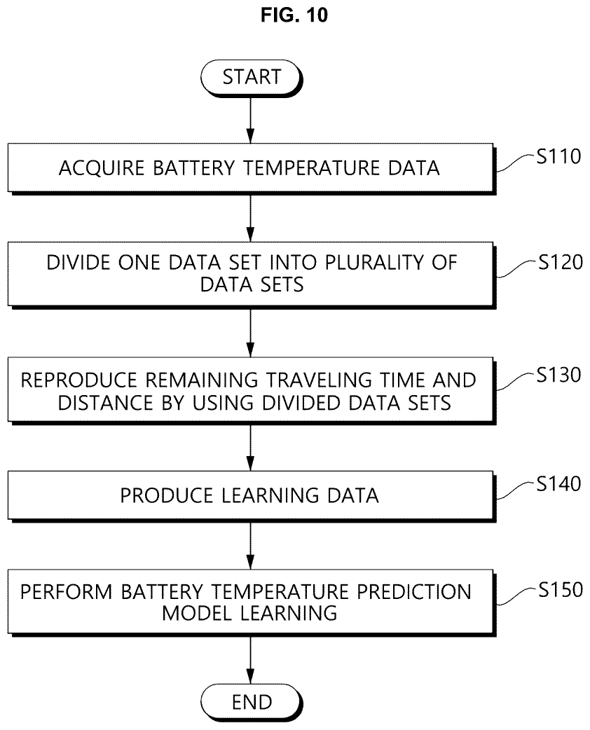

FIG. 10 is a flowchart for explaining a learning process of the battery temperature prediction model in the present disclosure.

With reference to FIG. 10, the model learning device 1000 may apply an over-scaling technique to solve a problem of insufficient learning data when the model learning device 1000 learns the data of the battery temperature prediction model 132.

In a data acquisition step S110, the model learning device 1000 may acquire data related to the battery temperature from the vehicle traveling information.

In a data division step S120, the model learning device 1000 may arbitrarily divide the single data set, which is provided on the basis of the data related to the battery temperature, into the plurality of data sets. In this case, redundancy may be allowed.

In a data reproduction step S130, the model learning device 1000 may set the last value of the plurality of divided data sets as the destination arrival time point and reproduce data related to the battery temperature by calculating the remaining traveling time and the distance to the destination.

In a learning data production step S140, the model learning device 1000 may designate the last value of the current battery temperature in the data related to the reproduced battery temperature to the battery temperature (the model learning value and the target value) of the destination arrival time point. The model learning device 1000 may set the target battery temperature by subtracting the battery temperature at the destination arrival time point from the current battery temperature.

With the above-mentioned method, the model learning device 1000 may ensure the plurality of data sets by means of the single data set. Therefore, it is possible to solve the problem of insufficient learning data.

In a learning step S150, the model learning device 1000 may learn the battery temperature prediction model 132 by using the remaining traveling time, the outside air temperature, and the current battery temperature as the input values.

The temperature prediction device 130 may predict the battery temperature at the designated destination arrival time point by the completely learned battery prediction model 132. In the embodiment, the temperature prediction device 130 may output the target battery temperature by subtracting the battery temperature at the designated destination arrival time point from the current battery temperature in accordance with the temperature prediction result. The temperature prediction device 130 may use the target battery temperature by calculating the predicted battery temperature value at the destination arrival time point of the electric vehicle 10 that is traveling.

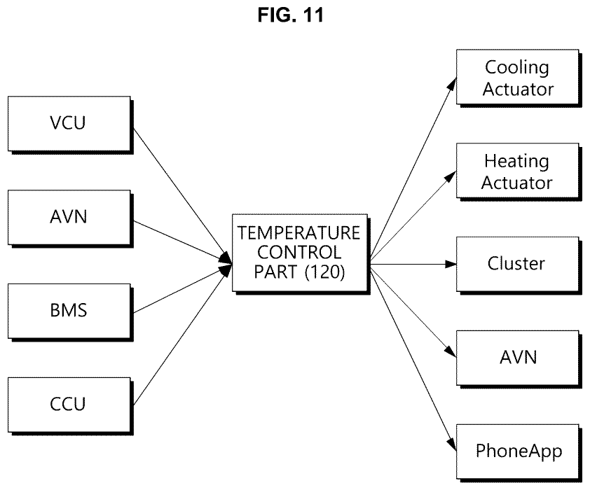

FIG. 11 is a view for explaining various types of vehicle information and an actuator device used for battery conditioning control.

With reference to FIG. 11, the temperature control device 120 may perform the battery conditioning control when the predicted battery temperature value enters the preset optimal temperature range. In this case, the temperature control device 120 may use various types of vehicle information and further determine whether the battery conditioning control is required.

Various types of vehicle information may include EV ready outputted from a vehicle control unit (VCU), whether the actuator fails, and a distance to empty (DTE). In addition, various types of vehicle information may include a distance remaining to the destination outputted from audio video navigation (AVN), whether a fast charging station destination is set, and the time remaining to the destination. In addition, various types of vehicle information may include a battery temperature outputted from a battery management system (BMS), a battery state of charge (SOC), and the time required to heat or cool the battery. In addition, various types of vehicle information may include manual button ON/OFF states and departure time settings outputted from the AVN. In addition, various types of vehicle information may include ON/OFF states of a mobile phone app that communicates with a combined charging unit (CCU).

When the temperature control device 120 determines that the battery conditioning control is required, the temperature control device 120 may control the cooling actuator or the heating actuator by using the battery actuator output target.

In addition, the temperature control device 120 may display a battery conditioning operating state in a pop-up manner by controlling a cluster.

In addition, the temperature control device 120 may display the battery temperature state and the battery conditioning operating state in a pop-up manner by controlling the AVN.

In addition, the temperature control device 120 may display the battery temperature state and the battery conditioning operating state in a pop-up manner while communicating with the mobile phone app.

The above description is simply given for illustratively describing the technical spirit of the present disclosure, and those skilled in the art to which the present disclosure pertains will appreciate that various modifications, changes, and substitutions are possible without departing from the essential characteristics of the present disclosure. Accordingly, the embodiments disclosed in the present disclosure and the accompanying drawings are intended not to limit but to describe the technical spirit of the present disclosure, and the scope of the technical spirit of the present disclosure is not limited by the embodiments and the accompanying drawings.

The steps and/or the operations according to the present disclosure may be simultaneously incurred in other exemplary embodiments in another order, in parallel, or for another epoch, which will be understood by those skilled in the art.

Depending on an exemplary embodiment, a device or all of the steps and/or the operations may be implemented or performed by using one or more processors driving a command stored in one or more non-temporary computer-readable media, a program, an interactive data structure, a client, and/or a server. An example of the one or more non-temporary computer-readable media may be software, firmware, hardware, and/or any combination thereof. Further, a function of “module” discussed in the present specification may be implemented by software, firmware, hardware, and/or any combination thereof.

As described above, the exemplary embodiments have been described and illustrated in the drawings and the specification. The exemplary embodiments were chosen and described in order to explain certain principles of the disclosure and their practical application, to thereby enable others skilled in the art to make and utilize various exemplary embodiments of the present disclosure, as well as various alternatives and modifications thereof. As is evident from the foregoing description, certain aspects of the present disclosure are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the disclosure are deemed to be covered by the disclosure which is limited only by the claims which follow.

What is claimed is:

1. A battery management system for a vehicle using a battery temperature prediction model, the battery management system comprising:
a transmission/reception device configured to receive information of the vehicle;
a temperature control device configured to request prediction of a battery temperature at a destination arrival time point by using destination information and perform battery conditioning control by using a predicted battery temperature value according to a request result; and
a temperature prediction device configured to output the predicted battery temperature value at the destination arrival time point by inputting the information to a battery temperature prediction model, which is provided in advance, in accordance with the request for the prediction of the battery temperature.

2. The battery management system of claim 1, wherein the vehicle is an electric vehicle.

3. The battery management system of claim 2, wherein the information includes information related to a trip of the electric vehicle.

4. The battery management system of claim 1, wherein the information comprises the destination information, a remaining traveling time, an outside air temperature, a current battery temperature, a rotational speed of an electronic compressor (E-compressor) configured to operate a cooling or heating device, and a coolant temperature.

5. The battery management system of claim 1, further comprising:
a model learning device configured to reproduce data related to the battery temperature by dividing a single data set, which is provided on the basis of data related to the battery temperature of the information of the vehicle, into a plurality of data sets, setting a last value of the plurality of divided data sets as a destination arrival time point, and calculating a remaining traveling time to a destination when the battery temperature prediction model is learned.

6. The battery management system of claim 5, wherein the model learning device produces learning data by designating a last value of the current battery temperature in the data related to the reproduced battery temperature to a battery temperature at the destination arrival time point and setting a target battery temperature by subtracting the battery temperature at the destination arrival time point from the current battery temperature.

7. The battery management system of claim 6, wherein the model learning device learns the battery temperature prediction model by using a remaining traveling time, an outside air temperature, and a current battery temperature as input values.

8. The battery management system of claim 1, wherein the temperature prediction device calculates the predicted battery temperature value at the destination arrival time point by subtracting a target battery temperature, which is set by the battery temperature prediction model, from the current battery temperature in accordance with the request for the battery temperature prediction.

9. The battery management system of claim 1, wherein the battery temperature prediction model is divided into at least three regions by model partitioning to constitute a pipeline.

10. The battery management system of claim 1, wherein the temperature control device determines whether a destination of the vehicle is a charging station on the basis of the information, and
wherein the temperature control device performs the battery conditioning control depending on whether the predicted battery temperature value enters a preset optimal temperature range when the destination is the charging station.

11. A vehicle comprising the battery management system of claim 1.

12. An electric vehicle comprising the battery management system of claim 1.

13. A battery management method of a vehicle using a battery temperature prediction model, the battery management method comprising:
receiving, by a transmission/reception device, information of the vehicle;
requesting, by a temperature control device, prediction of a battery temperature at a destination arrival time point by using destination information of the information;
outputting, by a temperature prediction device, the predicted battery temperature value at the destination arrival time point by inputting the information to a battery temperature prediction model, which is provided in advance, in accordance with the request for the prediction of the battery temperature; and
performing, by the temperature control device, battery conditioning control by using a predicted battery temperature value according to a request result.

14. The battery management method of claim 13, wherein the information comprises the destination information, a remaining traveling time, an outside air temperature, a current battery temperature, a rotational speed of an electronic compressor (E-compressor) configured to operate a cooling or heating device, and a coolant temperature.

15. The battery management method of claim 13, further comprising:
acquiring, by a model learning device, data related to the battery temperature of the information of the vehicle before the temperature prediction request step;
dividing, by the model learning device, a single data set, which is provided on the basis of data related to the battery temperature of the information of the vehicle, into a plurality of data sets; and
reproducing, by the model learning device, data related to the battery temperature by setting a last value of the plurality of divided data sets as a destination arrival time point and calculating a remaining traveling time to a destination.

16. The battery management method of claim 15, further comprising:
producing, by the model learning device after the reproducing step, learning data by designating a last value of a current battery temperature in the data related to the reproduced battery temperature to the battery temperature at the destination arrival time point and setting a target battery temperature by subtracting the battery temperature at the destination arrival time point from the current battery temperature.

17. The battery management method of claim 16, further comprising:
learning, by the model learning device after the producing step, the battery temperature prediction model by using a remaining traveling time, an outside air temperature, and a current battery temperature as input values.

18. The battery management method of claim 13, wherein the outputting step comprises calculating, by the temperature prediction device, the predicted battery temperature value at the destination arrival time point by subtracting a target battery temperature, which is set by the battery temperature prediction model, from a current battery temperature in accordance with the request for the prediction of the battery temperature.

19. The battery management method of claim 13, wherein the battery temperature prediction model is divided into at least three regions by model partitioning to constitute a pipeline.

20. The battery management method of claim 13, further comprising:
determining, by the temperature control device after the receiving step, whether a destination of the vehicle is a charging station on the basis of the traveling information; and
determining, by the temperature control device after the outputting step, whether the predicted battery temperature value enters a preset optimal temperature range when the destination is the charging station.
